(19) United States
(12) Patent Application Publication
(10) Pub. No.: US 2010/0150521 A1
(43) Pub. Date: Jun. 17, 2010

(54) SYSTEM AND METHOD FOR CONTENT PLAYBACK CONTROL ACROSS MULTIPLE ACCESS MEDIUMS

(75) Inventors: LEE M. CHOW, Naperville, IL (US); David Piepenbrink, Chicago, IL (US); James T. Sofos, Aurora, IL (US)

Correspondence Address: AT&T Legal Department - GMG;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/333,519

(22) Filed: Dec. 12, 2008

(51) Int. Cl. H04N 5/91; H04N 7/173

(52) U.S. Cl. 386/68; 725/131

(57) ABSTRACT

A system that incorporates teachings of the present disclosure may include, for example, a controller to enable trick mode bookmarking of media content presented at one of multiple access mediums including at least an interactive television system, a mobile communication device, and a computer, and receive a transfer of a state of presentation of the media content from one of the multiple access mediums according to a trick mode bookmark. Other embodiments are disclosed.

### FIELD OF THE DISCLOSURE

The present disclosure relates generally to content playback control and more specifically to a system and method for content playback control across multiple access mediums.

### BACKGROUND

It is common today for a user to purchase media content such as a movie from a media content portal (e.g., iTunes™). The purchased content is generally consumable on the device that receives the content such as for example a personal computer. In some instances, the portal can supply the content as a streamed signal with trick play options such as playback, pause, fast forward, and rewind. Accordingly, a user can pause the purchased content, forward and playback the content at another point in time, or resume playback from a point of departure.

### BRIEF DESCRIPTION OF THE DRAWINGS

FIG. 1 depicts an illustrative embodiment of a communication system;

FIG. 2 depicts an illustrative embodiment of a portal interacting with the communication system of FIG. 1;

FIG. 3 depicts an illustrative embodiment of a communication device utilized in the communication system of FIG. 1;

FIG. 4 depicts an illustrative embodiment of a method operating in portions of the communication system of FIG. 1; and

FIG. 5 is a diagrammatic representation of a machine in the form of a computer system within which a set of instructions, when executed, may cause the machine to perform any one or more of the methodologies discussed herein; and

FIG. 6 is diagrammatic representation of a system enabling content playback control across multiple access mediums in accordance with one or more embodiments herein.

### DETAILED DESCRIPTION

One embodiment of the present disclosure can entail enabling trick mode bookmarking of streamed media content presented by one of a plurality of presentation applications comprising an interactive TV (iTV) application, a mobile communication device application, and a personal computing device application, maintaining a state of presentation of the streamed media content according to a corresponding trick mode bookmark supplied by the presentation application presenting the streamed media content, and resuming presentation of the streamed media content according to the trick mode bookmark at another one of the plurality of presentation applications.

Another embodiment of the present disclosure can entail enabling trick mode bookmarking across multiple access mediums, and transferring a state of presentation of media content from a first access medium to a second access medium according to a trick mode bookmark.

Yet another embodiment of the present disclosure can entail a computer-readable storage medium having computer instructions for enabling trick mode bookmarking across multiple access mediums including an iTV system, a mobile communication device, a computer, and a media player, and transferring a state of presentation of media content from a first access medium to a second access medium according to a trick mode bookmark. The state of presentation of the media content can be accessible to the multiple access mediums.

Yet another embodiment of the present disclosure can entail a device having a controller to enable trick mode bookmarking of media content presented at one of multiple access mediums including at least an iTV system, a mobile communication device, and a computer, and receive a transfer of a state of presentation of the media content from one of the multiple access mediums according to a trick mode bookmark.

Yet another embodiment of the present disclosure can entail a communication device having a controller to receive media content, initiate a trick mode function, record a trick mode bookmark associated with a result of the trick mode function, and transmit the trick mode bookmark to resume presentation of the media content at another communication device.

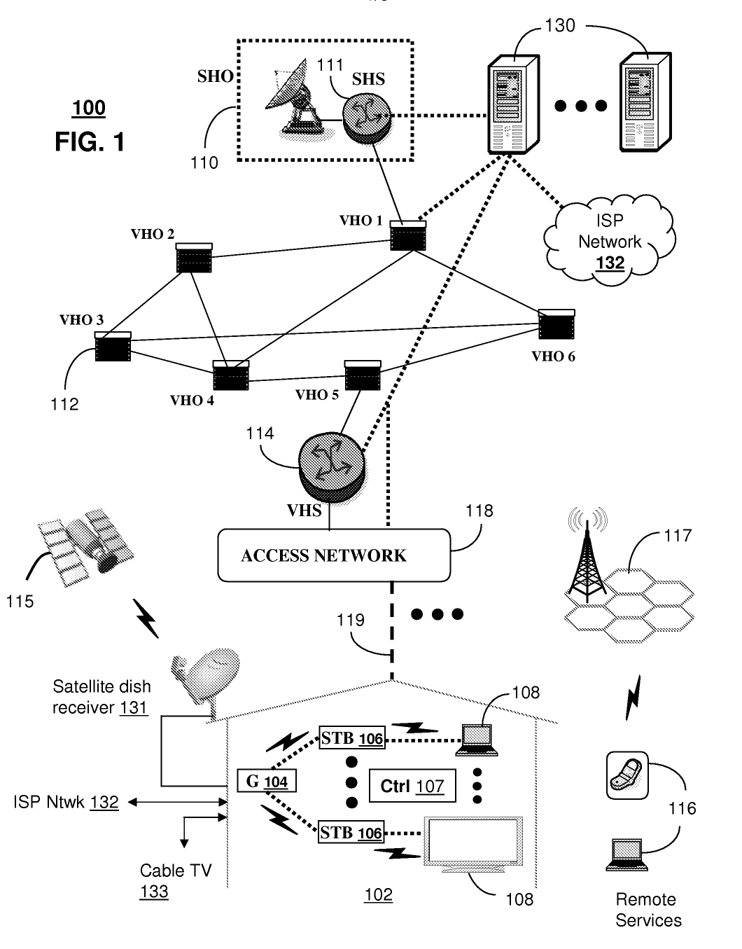

FIG. 1 depicts an illustrative embodiment of a first communication system 100 for delivering media content. The communication system 100 can represent an Internet Protocol Television (IPTV) broadcast media system. The IPTV media system can include a super head-end office (SHO) 110 with at least one super headend office server (SHS) 111 which receives media content from satellite and/or terrestrial communication systems. In the present context, media content can represent audio content, moving image content such as videos, still image content, or combinations thereof. The SHS server 111 can forward packets associated with the media content to video head-end servers (VHS) 114 via a network of video head-end offices (VHO) 112 according to a common multicast communication protocol.

The VHS 114 can distribute multimedia broadcast programs via an access network 118 to commercial and/or residential buildings 102 housing a gateway 104 (such as a common residential or commercial gateway). The access network 118 can represent a group of digital subscriber line access multiplexers (DSLAMs) located in a central office or a service area interface that provide broadband services over optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered interface technologies (such as coaxial or phone line wiring) or can operate over a common wireless access protocol. With these interfaces, unicast communications can be invoked between the media processors 106 and subsystems of the IPTV media system for services such as video-on-demand (VoD), browsing an electronic programming guide (EPG), or other infrastructure services.

Some of the network elements of the IPTV media system can be coupled to one or more computing devices 130 a portion of which can operate as a web server for providing portal services over an Internet Service Provider (ISP) network 132 to wireline media devices 108 or wireless communication devices 116 by way of a wireless access base station 117 operating according to common wireless access protocols such as Wireless Fidelity (WiFi), or cellular communication technologies (such as GSM, CDMA, UMTS, WiMAX, Software Defined Radio or SDR, and so on).

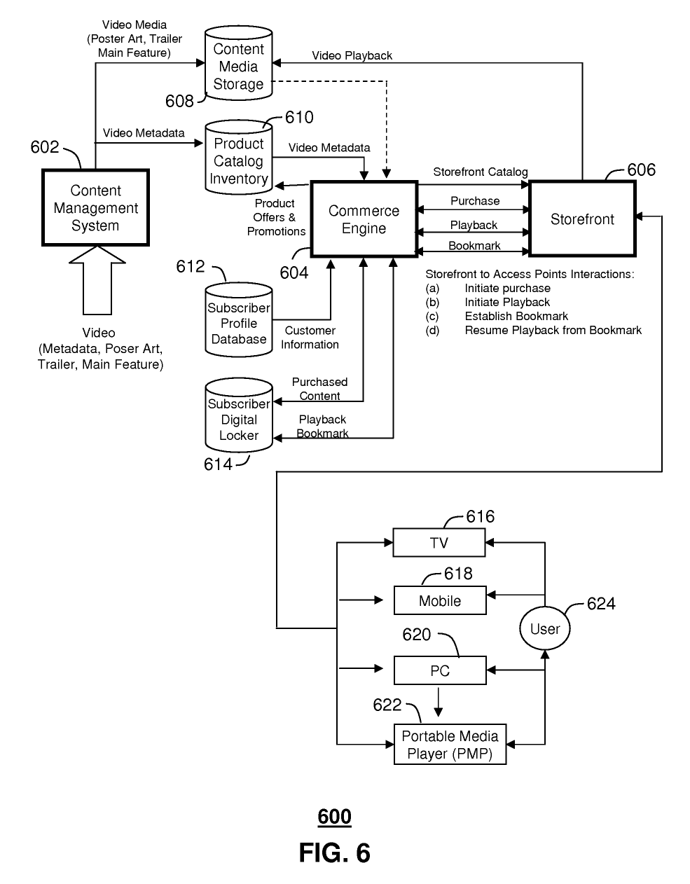

Another distinct portion of the computing devices 130 can function as a portal or server (herein referred to as server 130). The server 130 can use computing and communication technology to perform the function of providing a common portal or storefront to various access mediums as can be more clearly understood with reference to FIG. 6. The server 130 can include one or more servers providing managed access to content, subscriber data, and state information that can persist for use among the various access mediums in accordance with the embodiments herein.

It will be appreciated by an artisan of ordinary skill in the art that a satellite broadcast television system can be used in place of the IPTV media system. In this embodiment, signals transmitted by a satellite 115 supplying media content can be intercepted by a common satellite dish receiver 131 coupled to the building 102. Modulated signals intercepted by the satellite dish receiver 131 can be submitted to the media processors 106 for generating broadcast channels which can be presented at the media devices 108. The media processors 106 can be equipped with a broadband port to the ISP network 132 to enable infrastructure services such as VoD and EPG described above.

In yet another embodiment, an analog or digital broadcast distribution system such as cable TV system 133 can be used in place of the IPTV media system described above. In this embodiment the cable TV system 133 can provide Internet, telephony, and interactive media services.

It follows from the above illustrations that the present disclosure can apply to any present or future interactive over-the-air or landline media content services.

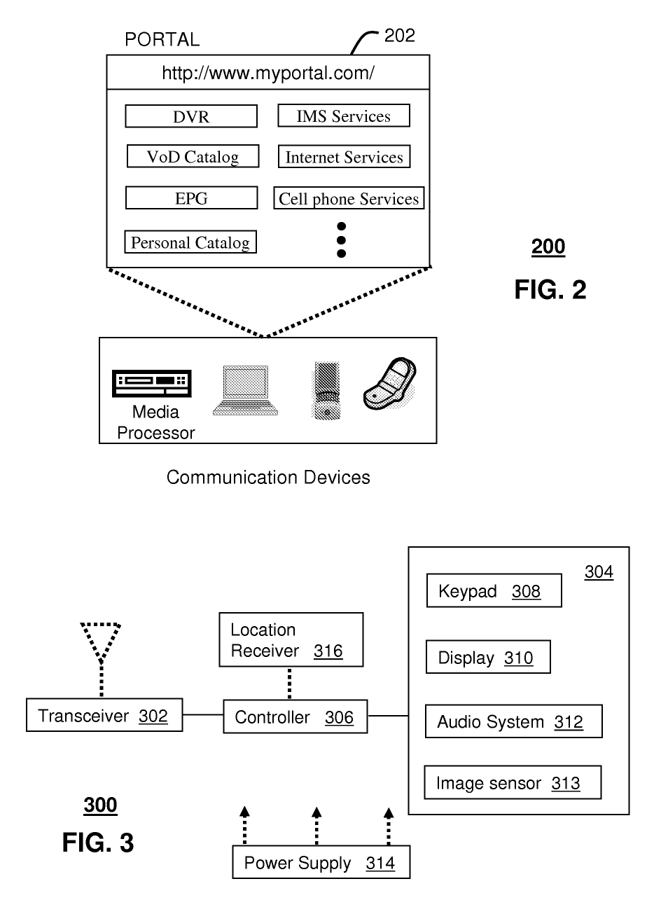

FIG. 2 depicts an illustrative embodiment of a portal 202 which can operate from the computing devices 130 described earlier of communication 100 illustrated in FIG. 1. The portal 202 can be used for managing services of communication systems 100-200. The portal 202 can be accessed by a Uniform Resource Locator (URL) with a common Internet browser such as Microsoft's Internet Explorer™ using an Internet-capable communication device such as those described for FIGS. 1-2. The portal 202 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services described earlier, provisioning Internet services, provisioning cellular phone services, and so on.

FIG. 3 depicts an exemplary embodiment of a communication device 300. Communication 300 can serve in whole or in part as an illustrative embodiment of the communication devices of FIGS. 1-2. The communication device 300 can comprise a wireline and/or wireless transceiver 302 (herein transceiver 302), a user interface (UI) 304, a power supply 314, a location receiver 316, and a controller 306 for managing operations thereof. The transceiver 302 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, and next generation cellular wireless communication technologies as they arise. The transceiver 402 can also be adapted to support circuit-switched wireline access technologies (such as PSTN), packet-switched wireline access technologies (such as TCPIP, VoIP, etc.), and combinations thereof.

The UI 304 can include a depressible or touch-sensitive keypad 308 with a navigation mechanism such as a roller ball, joystick, mouse, or navigation disk for manipulating operations of the communication device 300. The keypad 308 can be an integral part of a housing assembly of the communication device 300 or an independent device operably coupled thereto by a tethered wireline interface (such as a USB cable) or a wireless interface supporting for example Bluetooth. The keypad 308 can represent a numeric dialing keypad commonly used by phones, and/or a Qwerty keypad with alphanumeric keys. The UI 304 can further include a display 310 such as monochrome or color LCD (Liquid Crystal Display), OLED (Organic Light Emitting Diode) or other suitable display technology for conveying images to an end user of the communication device 300. In an embodiment where the display 310 is touch-sensitive, a portion or all of the keypad 308 can be presented by way of the display.

The UI 304 can also include an audio system 312 that utilizes common audio technology for conveying low volume audio (such as audio heard only in the proximity of a human ear) and high volume audio (such as speakerphone for hands free operation). The audio system 312 can further include a microphone for receiving audible signals of an end user. The audio system 412 can also be used for voice recognition applications. The UI 304 can further include an image sensor 313 such as a charged coupled device (CCD) camera for capturing still or moving images.

The power supply 314 can utilize common power management technologies such as replaceable and rechargeable batteries, supply regulation technologies, and charging system technologies for supplying energy to the components of the communication device 300 to facilitate long-range or short-range portable applications. The location receiver 316 can utilize common location technology such as a global positioning system (GPS) receiver for identifying a location of the communication device 100 based on signals generated by a constellation of GPS satellites, thereby facilitating common location services such as navigation.

The communication device 100 can use the transceiver 402 to also determine a proximity to a cellular, WiFi or Bluetooth access point by common power sensing techniques such as utilizing a received signal strength indicator (RSSI) and/or a signal time of arrival (TOA) or time of flight (TOF). The controller 306 can utilize computing technologies such as a microprocessor, a digital signal processor (DSP), and/or a video processor with associated storage memory such a Flash, ROM, RAM, SRAM, DRAM or other storage technologies.

The communication device 300 can be adapted to perform the functions of the media processor 106, the media devices 108, or the portable communication devices 56 of FIG. 1. It will be appreciated that the communication device 300 can also represent other common devices that can operate in communication systems 100 of FIG. 1 such as a gaming console and a media player.

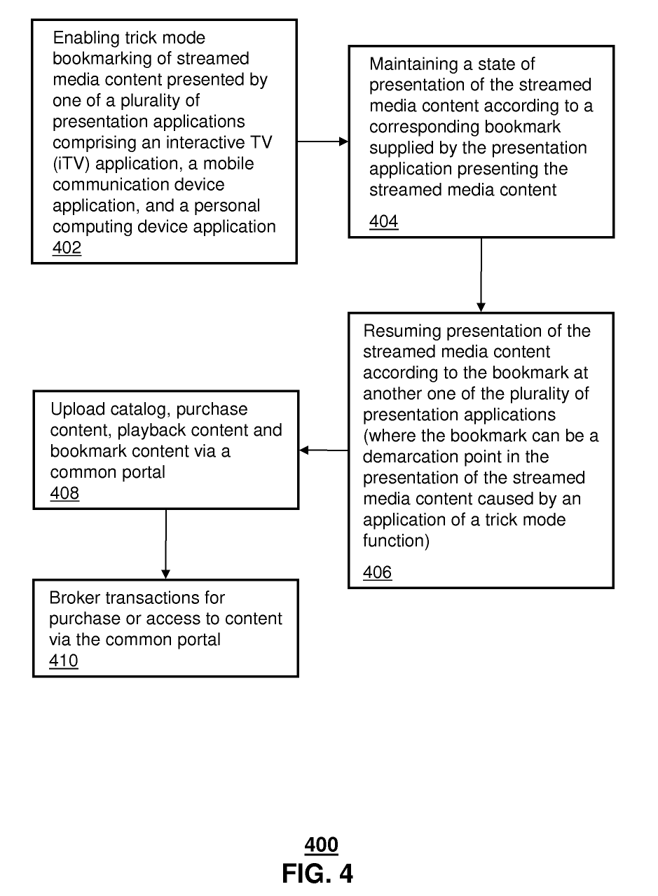

FIG. 4 depicts an illustrative method 400 that operates in portions of the communication system of FIG. 1. Method 400 at 402 enables trick mode bookmarking of streamed media content presented by one of a plurality of presentation applications comprising an interactive TV (iTV) application, a mobile communication device application, and a personal computing device application. The method at 404 maintains a state of presentation of the streamed media content according to a corresponding trick mode bookmark supplied by the presentation application presenting the streamed media content and at 406 the method resumes presentation of the streamed media content according to the trick mode bookmark at another one of the plurality of presentation applications. Also note that a portable media player operatively coupled to a computing device having the personal computing device application can also be enabled to perform the trick mode bookmarking method as well. The iTV application can operate as an Internet Protocol TV system, a cable TV system, and a satellite TV system for example. At step 408, the plurality of presentation applications can upload catalogs, purchase content, playback content and bookmark content via the portal or Storefront. The method 400 can also broker transactions for purchase of streamed media content via the portal at 410.

The trick mode bookmarking can be enabled for content subscribed to by an authenticated subscriber via a storefront portal. The trick mode bookmark can provide a demarcation point of presentation resulting from running any of the trick mode functions such as pause, forward, rewind, and slow motion. With the demarcation point you can restart a presentation on any of the applications or screens. Further note that the quality of presentation can differ from one application to the next to adapt to the particular application or screen. For example, the quality of presentation from a mobile phone to a set top box can actually be adjusted for higher quality on the set top box and accompanying television set.

Upon reviewing the aforementioned embodiments, it would be evident to an artisan with ordinary skill in the art that said embodiments can be modified, reduced, or enhanced without departing from the scope and spirit of the claims described below. For example, the access mediums are not limited to iTV, IPTV, personal computers, mobile communication devices, and portable media players, but can include almost any device or service capable of presenting digital data assuming the formatting between or across access mediums can be appropriately translated or modified to enable suitable display or other presentation. Furthermore, an order for the aforementioned steps in FIG. 4 should not necessarily be implied since the steps can be done in any number of different arrangements where the order is modified or where certain steps are omitted or where additional steps are further included.

As an example, another embodiment within contemplation of the scope of the claims can include a method that maintains a state of presentation of a streamed media content according to a bookmark supplied by a presentation application presenting the streamed media content where the presentation application is among one of a plurality of presentation applications and where the presentation of the streamed media content resumes according to the bookmark at another one of the plurality of presentation applications. This method can be adapted to perform a trick mode function where the trick mode function can be one of a playback function applied to the streamed media content, a pause function applied to the streamed media content, a forward function applied to the streamed media content, and a rewind function applied to the streamed media content, and where the bookmark is a trick mode bookmark corresponding to a demarcation point in the presentation of the streamed media content caused by an application of the trick mode function.

Other suitable modifications can be applied to the present disclosure without departing from the scope of the claims below. Accordingly, the reader is directed to the claims section for a fuller understanding of the breadth and scope of the present disclosure.

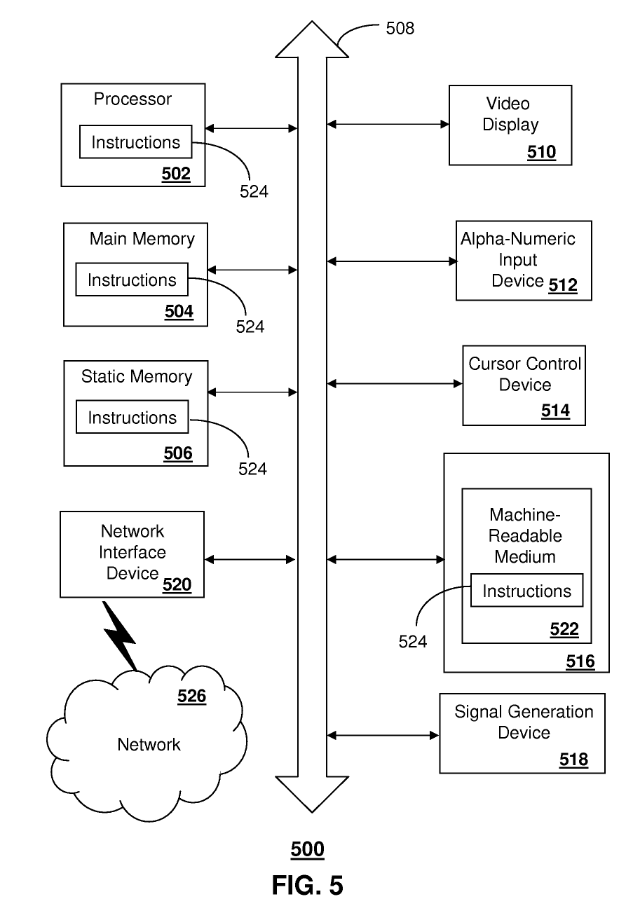

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated above. The instructions 524 may also reside, completely or at least partially, within the main memory 504, the static memory 506, and/or within the processor 502 during execution thereof by the computer system 500. The main memory 504 and the processor 502 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

Referring to FIG. 6, a system 600 is illustrated that presents a particular embodiment enables bookmarking, trick modes or other control of content playback from multiple access mediums such as “3-screen applications” that can include televisions, mobile devices (e.g., cellular phones, personal digital assistants) and computers (e.g., laptops and desktop computers). Such a system can offer content (e.g., video-on-demand, Over-the-Top streaming video, Download & Play video, etc.) to be consumable across multiple access mediums, including the TV 616, a broadband portal 620, mobile/cell phone device 618 and Portable Media Players (PMPs) 622. Such content can be browsed, sampled and purchased from a common portal or Storefront 606.

The purchased or requested content can be consumable (playback-enabled) across the multiple access mediums as requested by a user 624. For example, the user 624 can pause the playback of purchased or requested content in one access medium (for example, broadband TV) and establish a bookmark. The user 624 can then be able to resume the content playback on any other access medium (for example, mobile phone, PC or PMP) from the pre-established bookmark.

Such a system or architecture for control across access mediums can include a Content Management System 602, which discovers, acquires, ingests, formats and encodes raw content, Content Media Storage 608, which stores all media files associated with the content, including any poster art, trailer and main feature media files, a centralized Product Catalog 610, which maintains an inventory of all offerable content and any associated offers or promotions, and a Subscriber Database 612 which contains customer information, including service profiles and geographic location. The system 600 can further include a Subscriber Digital Locker 614 which tracks customers' access rights for specific content (such as purchased, free, gifted content) and a Commerce Engine 604 coupled to the Storefront 606 which maintains the Storefront content and customers' rights to the content. The Storefront 606 can include a Storefront application which brokers interactions to each of the Storefront access mediums (616-622). Further details of the components are described below.

The Content Management System 602 acquires and ingests content and then formats the content into an appropriate consumption platform and encodes the content if necessary. The Content Media Storage 608 centrally stores content such as content poster art images, a trailer and main feature media files where it is distributed to the user's access medium (PC, TV, mobile/cell phone device). The Product Catalog/Inventory 610 can include metadata for all ingested content that is centrally stored in a common Product Catalog where it can be made into sellable units and monetized via the commerce engine 604. The Subscriber Profile Database 612 can be a central storage that can include all customer information needed to manage content rights for subscribers. Information on the customer's service profile, geographic and demographic information can be persisted. The Subscriber Digital Locker 614 can include all content that a specific customer has access to (such as purchased content, gifted content, uploaded content, free content) and specific associated customer content information can be stored in the Subscriber Digital Locker as well. It is in the Digital Locker where the customer's Bookmarks for content playback across “3-screens” or across the multiple access mediums is persisted.

The Commerce Engine 604 enables service providers to create publishable Storefront content by taking ingested content information and transforming them into sellable units (definitions of bundles, offers, promotions). The Commerce Engine 604 publishes the Storefront inventory to the Storefront application 606 where the user 624 can access it via the multiple access mediums (PC, TV, mobile device, PMP). The Commerce Engine 604 can also broker user transactions via the Storefront 606 (by enabling the browsing of the catalog, enabling purchase requests, etc.). The Storefront 606 can be an eCommerce application that enables the access of content for browsing, sampling, purchasing and consumption via the “3-screen” or multiple access mediums. The embodiments herein enable ingested content to be accessible via the multiple access mediums and enable the coordination of access controls across all the access mediums. The user can gain rights to playback a piece of content via any one of the multiple access mediums (TV, PC, mobile/cell phone), pause the playback and establish a bookmark. The bookmark is then centrally persisted for the user 624 in the Digital Locker 614. Subsequently, the bookmark can be recalled across any access medium by the same user, enabling the user 624 to resume playback of the content at the specified, previously-established bookmark.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
enabling trick mode bookmarking of streamed media content presented by one of a plurality of presentation applications comprising an interactive TV (iTV) application, a mobile communication device application, and a personal computing device application;
maintaining a state of presentation of the streamed media content according to a corresponding trick mode bookmark supplied by the presentation application presenting the streamed media content; and
resuming presentation of the streamed media content according to the trick mode bookmark at another one of the plurality of presentation applications.

2. The method of claim 1, comprising enabling content trick mode bookmarking of a portable media player operatively coupled to a computing device having the personal computing device application.

3. The method of claim 1, wherein the iTV application operates in one of an Internet Protocol TV system, a cable TV system, and a satellite TV system.

4. The method of claim 1, comprising enabling trick mode bookmarking for content subscribed to by an authenticated subscriber via a storefront portal.

5. The method of claim 1, comprising enabling access to streamed media content across the plurality of presentation applications via a portal.

6. The method of claim 5, wherein the plurality of presentation applications upload catalogs, purchase content, playback content and bookmark content via the portal.

7. The method of claim 5, comprising brokering transactions for purchase of streamed media content via the portal.

8. A method, comprising:
enabling trick mode bookmarking across multiple access mediums; and
transferring a state of presentation of media content from a first access medium to a second access medium according to a trick mode bookmark.

9. The method of claim 8, comprising maintaining the state of presentation of the media content in a server accessible to the multiple access mediums.

10. The method of claim 8, wherein the state of presentation of the media content includes a state of operation of an access medium supplying the trick mode bookmark, and wherein the access medium operates from one of a television device, a mobile communication device, a personal computer or a portable media player.

11. The method of claim 8, wherein the multiple access mediums operate from one of an interactive TV (iTV) system, a mobile communication device, and a personal computing device, and wherein the iTV system corresponds to one of an Internet Protocol TV system, a cable TV system, and a satellite TV system.

12. The method of claim 8, comprising enabling trick mode bookmarking for content subscribed to by an authenticated subscriber via a storefront portal and wherein the multiple access mediums can each upload catalogs, purchase content, playback content and bookmark content via the storefront portable serving as a common portal coupled to a commerce engine.

13. The method of claim 8, comprising brokering transactions for purchase of content via the storefront portal coupled to a commerce engine having access to subscriber information and the state of presentation of the media content according to the trick mode bookmark.

14. A computer-readable storage medium, comprising computer instructions for:
enabling trick mode bookmarking across multiple access mediums including an interactive television system, a mobile communication device, a computer, and a media player; and
transferring a state of presentation of media content from a first access medium to a second access medium according to a trick mode bookmark;
wherein the state of presentation of the media content is accessible to the multiple access mediums.

15. The computer-readable storage of claim 14, wherein the state of presentation of the media content includes a state of operation of an access medium supplying the trick mode bookmark.

16. A device, comprising a controller to:
enable trick mode bookmarking of media content presented at one of multiple access mediums including at least an interactive television system, a mobile communication device, and a computer; and
receive a transfer of a state of presentation of the media content from one of the multiple access mediums according to a trick mode bookmark.

17. The device of claim 16, wherein the controller is adapted to record the state of presentation of the media content in a server accessible to the multiple access mediums.

18. The device of claim 16, wherein the state of presentation of the media content includes a state of operation of an access medium supplying the trick mode bookmark, and wherein the access medium operates from one of a television device, a mobile communication device, a personal computer or a media player.

19. The device of claim 16, wherein the controller is adapted to perform a trick mode function, wherein the trick mode function comprises one of a playback function applied to the media content, a pause function applied to the media content, a forward function applied to the media content, and a rewind function applied to the media content, and wherein the trick mode bookmark corresponds to a demarcation point in the presentation of the media content caused by an application of the trick mode function.

20. A communication device, comprising a controller to:
receive media content;
initiate a trick mode function;
record a trick mode bookmark associated with a result of the trick mode function; and
transmit the trick mode bookmark to resume presentation of the media content at another communication device.

21. The communication device of claim 20, wherein the controller is adapted to transmit the trick mode bookmark to a system that supplied the media content to the communication device.

22. The communication device of claim 21, wherein the system comprises a Product Catalog which maintains an inventory of offerable media content and associated promotions, and wherein the system comprises a Subscriber Database with customer information, including service profiles and geographic location.

23. The communication device of claim 2021, wherein the trick mode bookmark corresponds to a state of presentation of the media content created by the initiated trick mode function, and wherein the communication device corresponds to one of a mobile phone, a set-top box, and a computer.

24. A method, comprising:
maintaining a state of presentation of a streamed media content according to a bookmark supplied by a presentation application presenting the streamed media content, wherein the presentation application is among one of a plurality of presentation applications; and
resuming presentation of the streamed media content according to the bookmark at another one of the plurality of presentation applications.

25. The method of claim 24, wherein the method is adapted to perform a trick mode function, wherein the trick mode function comprises one of a playback function applied to the streamed media content, a pause function applied to the streamed media content, a forward function applied to the streamed media content, and a rewind function applied to the streamed media content, and wherein the bookmark is a trick mode bookmark corresponding to a demarcation point in the presentation of the streamed media content caused by an application of the trick mode function.
